(19) United States
(12) Patent Application Publication
(10) Pub. No.: US 2008/0147373 A1
(43) Pub. Date: Jun. 19, 2008

(54) METHOD FOR ANALYZING THE DESIGN OF AN INTEGRATED CIRCUIT

(76) Inventors: Thomas Roessler, Munich (DE); Markus Hofsaess, Munich (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/611,009

(22) Filed: Dec. 14, 2006

(51) Int. Cl. G06F 17/50

(52) U.S. Cl. 703/14

(57) ABSTRACT

According to one aspect, a method for analyzing the design of an integrated circuit comprises performing a simulation of the integrated circuit design to obtain simulation results and automatically associating the obtained simulation results to layout elements of the integrated circuit.

### BACKGROUND OF THE INVENTION

This description is directed generally to a method for analyzing the design of an integrated circuit.

In advanced semiconductor technologies, conventional design rule checks such as geometric tests are no longer sufficient to ensure manufacturability. Due to the dependency of important aspects of the manufacturability of the integrated circuit, such as reliability and defect sensitivity, on electrical measures, it is necessary to obtain additional information relating such measures to the layout of the integrated circuit. This may be important, for example, for determining the probability of “DC fails” (i.e., failures during the power-up process of the integrated circuit or chip) through defects caused by particles. Therefore, there is a need for an analysis technique that reduces the probability of failure increases the yield of good devices in an integrated circuit production operation, which may provide significant economic benefits to the manufacturer. The devices made thereby will be more economical, and may also gain in reliability in operation.

### SUMMARY OF THE INVENTION

According to one aspect, a method for analyzing the design of an integrated circuit may comprise the steps of:
performing a simulation of said integrated circuit design to obtain simulation results; and
automatically associating the obtained simulation results to layout elements of said integrated circuit.

According to another aspect, a method of making an integrated circuit may include the step of forming a conductor layer having a pattern, with said pattern being chosen by steps comprising analyzing the design of an integrated circuit, said step of analyzing comprising the steps of:
performing a simulation of said integrated circuit design to obtain simulation results; and
automatically associating the obtained simulation results to layout elements of said integrated circuit.

According to yet another aspect, an integrated circuit may include a conductor layer having a pattern, with said pattern being chosen by steps comprising analyzing the design of an integrated circuit, said step of analyzing comprising the steps of:
performing a simulation of said integrated circuit design to obtain simulation results; and
automatically associating the obtained simulation results to layout elements of said integrated circuit.

According to another aspect, a method for analyzing an integrated circuit design may comprise the steps of:
providing a simulatable representation of said integrated circuit design;
performing a simulation of said integrated circuit to obtain simulation values;
providing a layout representation of said integrated circuit design; and
automatically associating the obtained simulation values to layout elements of said integrated circuit.

According to another aspect, a method of making an integrated circuit may include the step of forming a conductor layer having a pattern, with said pattern being chosen by steps comprising analyzing the design of an integrated circuit, said step of analyzing comprising the steps of:
providing a simulatable representation of said integrated circuit design;
performing a simulation of said integrated circuit to obtain simulation values;
providing a layout representation of said integrated circuit design; and
automatically associating the obtained simulation values to layout elements of said integrated circuit.

According to a further aspect, an integrated circuit may include a conductor layer having a pattern, with said pattern being chosen by steps comprising analyzing the design of an integrated circuit, said step of analyzing comprising the steps of:
providing a simulatable representation of said integrated circuit design;
performing a simulation of said integrated circuit to obtain simulation values;
providing a layout representation of said integrated circuit design; and
automatically associating the obtained simulation values to layout elements of said integrated circuit.

According to yet another aspect, there is provided a computer program comprising program code means for performing the steps of any one of the above methods when said program is run on a computer.

According to yet another aspect, there is provided a computer program product comprising program code means stored on a computer readable medium for performing any one of the above methods.

According to yet another aspect, there is provided a graphical representation of a layout of an integrated circuit, which may comprise a plurality of layout elements, wherein
electrical elements of the integrated circuit are represented by one or more of said layout elements; and
layout elements representing electrical elements having the same property are marked in the same way.

According to yet another aspect, a device for analyzing an integrated circuit design may comprise:
a simulator for performing a simulation of said integrated circuit design to obtain simulation values; and
an associating unit for automatically associating said obtained simulation values to layout elements of said integrated circuit.

According to yet another aspect, a device for analyzing an integrated circuit design may comprise:
a receiving unit for receiving a simulatable representation and a layout representation of said integrated circuit design;
a simulator for performing a simulation of said integrated circuit to obtain simulation values; and
an associating unit for automatically associating said obtained simulation values to layout elements of said integrated circuit.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a device for checking an integrated circuit design according to a first example;

FIG. 2 shows a flow diagram of a method for checking an integrated circuit design according to the first example;

FIG. 3 shows a device for checking an integrated circuit design according to a second example;

FIG. 4 shows a flow diagram of a method checking an integrated circuit design according to the second example; and

FIG. 5 shows a graphical representation of a part of a circuit design.

### DETAILED DESCRIPTION OF THE PREFERRED EMBODIMENT

In the following, a detailed description of examples will be given with reference to the drawings.

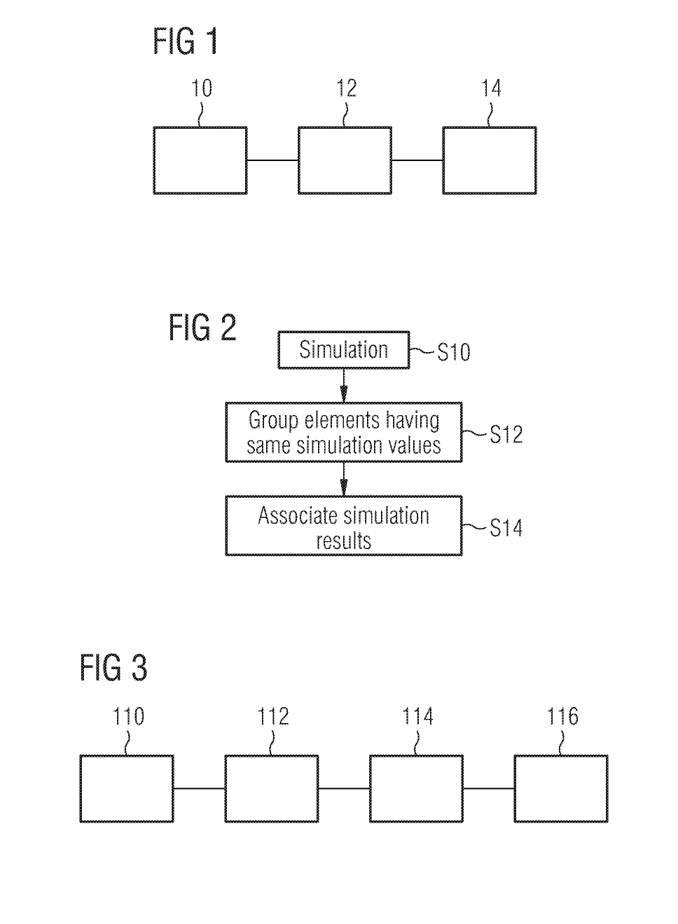

A first example will be described with reference to FIGS. 1 and 2.

FIG. 1 shows a device for analyzing an integrated circuit design according to a first example.

The device shown in FIG. 1 may comprise a simulator 10, an associating unit 12 and a grouping unit 14. Said simulator 10 performs a simulation of an integrated circuit design to obtain simulation values or results. Said associating unit 12 automatically associates said obtained simulation values or results to layout elements of said integrated circuit. Said grouping unit 14 groups circuit elements having simulation values associated thereto which are contained in a predefined range or ranges into groups. It should be understood that said grouping unit 14 is optional.

FIG. 2 shows a flow diagram of the first example of a method for analyzing the design of an integrated circuit.

In a first step S10, a simulation of the design of the integrated circuit is performed. For the simulation, the integrated circuit design may be provided in a simulatable representation. Such a simulatable representation may be a representation in the schematic, SPICE (Simulation Program with Integrated Circuits Emphasis), VHDL (Very High Speed Integrated Circuit Hardware Description Language) and/or any other net list format. A schematic is a diagram, drawing, or sketch that details the elements of a system, such as the elements of an electrical or electronic circuit. Net lists may comprise the textual description of connections between elements or gates of an integrated circuit design as well as the devices including their parameters and models. During such a simulation, various values or properties of the integrated circuit, in particular occurring at specified parts of the integrated circuit, may be determined. Such values may, in particular, be electrical properties such as voltages, currents, current densities or timing aspects occurring at or between different elements forming part of the integrated circuit.

In optional step S12, the elements or nodes of the integrated circuit may then be grouped in dependency of their associated values. For the grouping, value ranges for the obtained values may be defined which represent groups.

In step S14 the obtained simulation results or values are associated or assigned to layout elements or nodes of the integrated circuit in a corresponding layout representation. The layout representation of an integrated circuit, also known as IC layout or IC mask layout, is the representation of an integrated circuit in terms of planar geometric shapes that correspond to shapes or polygons actually drawn on photomasks used in semiconductor device fabrication. In the layout representation, an element of the schematic representation may be depicted by a plurality of polygons.

It should be understood that the order of execution of steps S12 and S14 may be changed.

Next, the grouped elements may be visualized and/or analyzed by analysis tools which are not described in detail herein.

By the association of the simulation values to the respective elements of the design of the integrated circuit, the evaluation of the integrated circuit design can be improved.

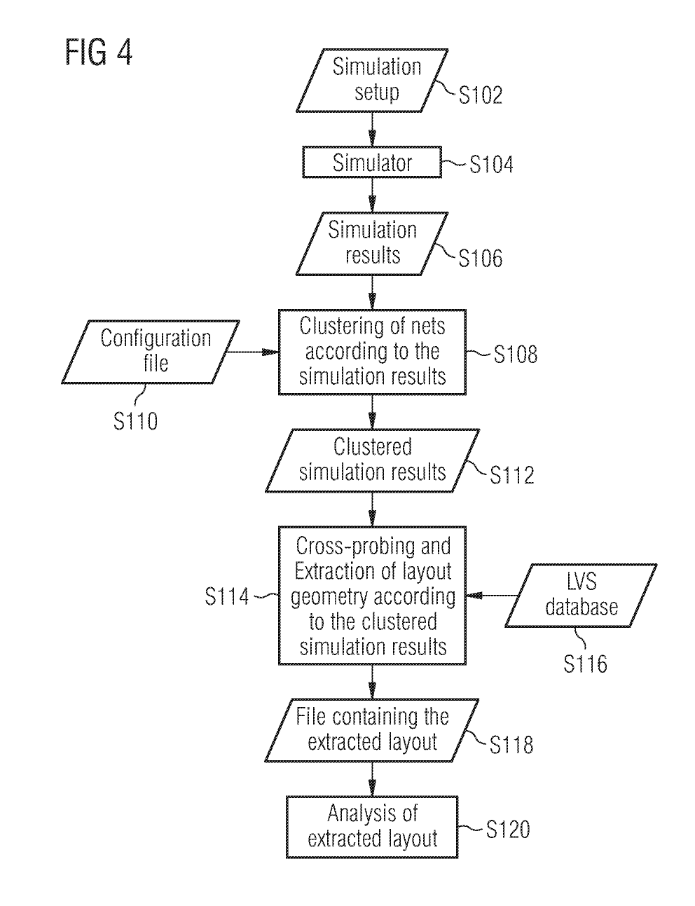

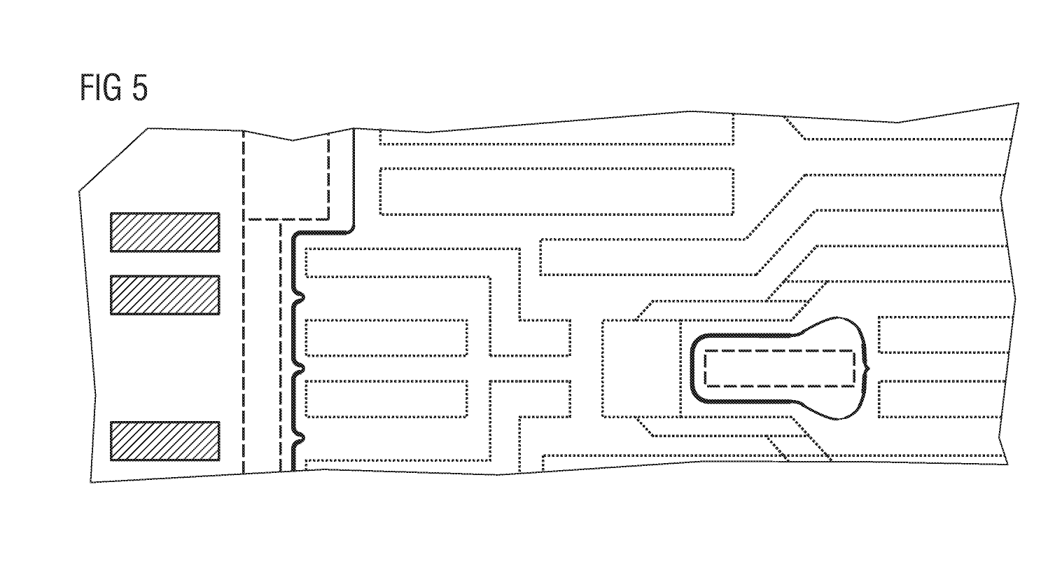

A second example of a method will be described with reference to FIGS. 3 and 4.

FIG. 3 shows a device for analyzing an integrated circuit design according to a second example.

The device shown in FIG. 3 may comprise a receiving unit 110, a simulator 112, an associating unit 114, and an optional grouping unit 116. Said receiving unit 110 performs the task of receiving a simulatable representation of said integrated circuit design. Said simulatable representation may be a schematic representation. Said simulator 112 performs a simulation of said integrated circuit to obtain simulation values. Said grouping unit 114 groups elements having the same simulation values associated thereto into groups. Said associating unit 116 automatically associates said obtained simulation values to layout elements of said integrated circuit in a layout representation of said integrated circuit. Said device may also comprise an analyzing unit (not shown) which performs an analysis of said layout representation.

FIG. 4 shows a flow diagram of the second example of a method for analyzing the design of an integrated circuit.

A simulation set up is created or provided with which nets and regions of the circuit are determined which are to be analyzed (Step S102). The simulation set up contains information about the integrated circuit design in the a simulatable representation of the integrated circuit. Such a simulatable representation may be a representation in the schematic, SPICE (Simulation Program with Integrated Circuits Emphasis), VHDL (Very High Speed Integrated Circuit Hardware Description Language) and/or any other net list format. A schematic is a diagram, drawing, or sketch that details the elements of a system, such as the elements of an electrical or electronic circuit. Net lists may comprise the textual description of connections between elements or gates of an integrated circuit design as well as the devices including their parameters and models.

Then a simulation of the integrated circuit is performed (Step S104). During the simulation, various data about the designed integrated circuit may be obtained. Such data may comprise voltage values, current values, current density values or timing values of elements in the integrated circuit design. Such values may be determined at nodes between electrical components of the integrated circuit. The simulation results may be stored in a file (Step S106).

The stored simulation results are grouped according to their simulation values (Step S108). The grouping may be performed, for example, based on simulated voltages present at specified parts of the integrated circuit at a specified point in time. In each group, circuit elements having the same voltage values or voltage values contained in a predetermined range are grouped together. In particular, the grouping gathers a plurality of elements having the same property. As stated above, such a property may be a voltage value or voltage value contained in a predetermined range, a current value or current value contained in a predetermined range, a delay time or any other suitable parameter for evaluating the circuit design. Clusters defining a value range may be defined, and the grouping may be performed on the basis of the clusters. For the grouping or clustering, a configuration file may be used in which the parameters for the grouping may be defined (S110). The clustered or grouped simulation results may be stored in step S112.

Then a so-called “cross-probing” and extraction of the layout geometry is performed (Step S114). During this step, the representation of the circuit design in the schematic representation is transferred into a layout representation. The layout representation of an integrated circuit, also known IC layout or IC mask layout, is the representation of an integrated circuit in terms of planar geometric shapes that correspond to shapes or polygons actually drawn on photomasks used in semiconductor device fabrication. In the layout representation, an element of the schematic representation may be depicted by a plurality of polygons.

For this step S114, a database (so-called LVS or layout versus schematic database) may be used (Step S116). Moreover, for each group, a specific layer in the layout representation may be created. That is, e.g., for all polygons in the layout representation having a predefined voltage value or voltage value range associated thereto, a separate layer in the layout representation may be created. Moreover, layers in the original layout which are different may be written to different layer types. Thus, for elements associated with a first group, the metal layer may be written to layer 1, datatype 1, and the polysilicon layer may be written to layer 1, datatype 2. Similarly, for elements associated with a second group, the metal layer may be written to layer 2, datatype 1 and the polysilicon layer may be written to layer 2, datatype 2.

By such proceeding, a file containing the extracted layout is obtained (Step S118). This file can be used for a subsequent display and/or analysis of the circuit design (Step S120). In the layout, the obtained simulation values are associated with layout elements and may be displayed.

FIG. 5 shows a part of a layout representation of an integrated circuit design to which the above described method has been applied. In the shown layout representation, polygons being associated with the same group are marked in a similar way. In the example given, there are three groups of voltages: a cluster or group of low voltages, a cluster or group of high voltages and a cluster or group with the remaining possible voltages. The polygons contained in the cluster with the low voltages are marked with dotted lines, whereas the polygons contained in the cluster with the high voltages are marked with a dashed line. The polygons which are hatched form part of the cluster with the intermediate voltages. Moreover, in FIG. 5 there are marked regions where polygons contained in the cluster of high voltages and polygons contained in the cluster of low voltages are adjacent to each other. Such regions are marked with bold lines. During operation of the integrated circuit, a short between these regions may cause failures. Thus, during the analysis of the integrated circuit design the regions marked with bold black lines may be particularly examined, and if necessary, the layout may be changed in order to avoid or minimize such regions.

In addition to the values described in the above examples, any electrical properties of interest for analyzing the integrated circuit may be associated with the layout elements of the integrated circuit design. Electrical properties may also comprise parameters describing the circuit behavior such as timing or delay. Such delay may be the times between rising and/or falling edges of a signal wave form.

In the manufacturing of an integrated circuit, a conductor layer having a pattern may be formed. Said pattern may be chosen by analyzing a layout. The pattern may be formed by the use of photomasks. The pattern may alternatively be formed without the use of a photomask, as in the case of direct-draw electron or ion beam radiation, for example. In that case, the radiation beam is directed sequentially over a device precursor to form the patterns of the desired layout. Hence, the radiation so patterned, whether by a mask or by directing the radiation beam, imparts a pattern to the devices formed on the integrated circuit. A multiplicity of masks or radiation beam exposure operations is typically used to form a multiplicity of patterned levels on the device precursor in order to form the integrated circuit, according to principles known in the art.

Furthermore, an integrated circuit may comprise a layout. Said layout may be analyzed by one of the above described methods.

The above described methods may be embodied in a computer program comprising program code means for performing the methods steps. Alternatively or additionally, the described methods may be embodied in a computer program product comprising program code means stored on a computer readable medium for performing any one of one of the above methods. The above described methods may also be provided as a subscription service for the user.

In the following, an example for the application of the above-described method will be given.

In the example, the wiring of a memory product of an advanced semiconductor technology will be considered. In the on-pitch circuits for controlling the reading and writing of data from and to the memory array, the layout of the wiring is very dense because of the stringent requirements with respect to the allowable space. Thus, there is a high risk of shorts caused by particle defects which connect adjacent circuits or conductor paths. In general, memory products are provided with redundant elements, so that a short is not a problem as long as it only affects the chip locally. On the other hand, a short between strongly differing voltages can cause the flowing current to be too high for the normal power-up process of the chip and can cause the chip to no longer power-up at all. This situation is called “DC fail” and cannot be remedied by the introduction of redundancy.

By the use of the above described methods, a simulation of the power-up process can be performed, and pairs of voltage regions can be defined between which a short would have serious consequences. These voltage regions may then be associated with polygons of the layout.

In the described methods, the simulation values obtained during the simulation of the integrated circuit design provided in a simulatable representation may be mapped or associated to respective elements in the layout representation of the integrated circuit design. Thus, simulation values associated with circuit elements in the simulatable representation are associated with elements of the layout representation representing respective circuit elements in the simulatable representation.

By enabling an automatic check of the manufacturability of the chip with respect to the possibility of “DC fail”, the so-called DC yield loss, i.e. the yield loss during power-up, can be reduced by adapting the layout or changing the production process. By such proceeding in the early phase of the design of integrated circuits, the number of functioning chips produced can be increased. In particular, it is very advantageous that portions of the design which may cause problems may already be discovered during the design phase and not only during the production phase.

The above described and other examples could be implemented in digital electronic circuitry, or in computer hardware, firmware, software, or in combinations of them. In particular, the examples could be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the described and other examples could be performed by one or more programmable processors executing a computer program to perform functions of the described and other examples by operating on input data and generating output. Method steps could also be performed by, and apparatus of the described and other examples could be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, the described and other examples could be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices could be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The described and other examples could also be implemented in a computing system that includes a back-end component, e.g., as a data server, or that includes a middleware component, e.g., an application server, or that includes a front-end component, e.g., a client computer having a graphical user interface or an Web browser through which a user can interact with an example or implementation, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of examples and implementations have been described. Other examples and implementations may, in particular, comprise one or more of the above features. Nevertheless, it will be understood that various modifications may be made. Accordingly, other implementations are within the scope of the following claims.

What is claimed is:

1. A method for analyzing a design of an integrated circuit, the method comprising:
performing a simulation of the design of the integrated circuit to obtain simulation results; and
automatically associating the obtained simulation results to layout elements of the integrated circuit.

2. The method according to claim 1, further comprising:
providing groups defining value ranges for the simulation results; and
assigning layout elements to the provided groups depending on their simulation values associated thereto.

3. The method according to claim 2, wherein the steps of performing the simulation and assigning the layout elements are performed in a simulatable representation of the integrated circuit, and the step of associating is performed in a layout representation of the integrated circuit.

4. The method according to claim 2, further comprising analyzing a group representation, wherein the analyzing step is performed in the layout representation of the integrated circuit.

5. The method according to claim 1, wherein the simulation results include electrical properties of the integrated circuit.

6. The method according to claim 1, wherein the simulation results comprise one or more of the following: voltage values, current values, current density values and timing values.

7. The method according to claim 2, further comprising displaying the design of the integrated circuit, wherein layout elements assigned to the same group are marked in the same manner.

8. The method according to claim 7, wherein a region between and/or around adjacent layout elements assigned to different groups is marked if a predetermined condition is fulfilled.

9. The method according to claim 3, wherein layout elements assigned to the same group are displayed in a one-layer representation of the layout representation.

10. The method according to claim 3, wherein the simulatable representation is a representation in at least one of a schematic, SPICE, VHDL and any other net list format.

11. A method of making an integrated circuit, comprising forming a conductor layer having a pattern chosen by analyzing a design of the integrated circuit, the analyzing comprising:
performing a simulation of said the design of the integrated circuit to obtain simulation results; and
automatically associating the obtained simulation results to layout elements of the integrated circuit.

12. The method according to claim 11, further comprising:
providing groups defining value ranges for the simulation results; and
assigning layout elements to the provided groups depending on their simulation values associated thereto.

13. The method according to claim 12, wherein the steps of performing the simulation and assigning layout elements are performed in a simulatable representation of the integrated circuit, and the step of associating is performed in a layout representation of the integrated circuit.

14. The method according to claim 12, further comprising analyzing a group representation, wherein the analyzing step is performed in the layout representation of the integrated circuit.

15. The method according to claim 11, wherein the simulation results include electrical properties of the integrated circuit.

16. The method according to claim 11, wherein the simulation results comprise one or more of the following: voltage values, current values, current density values and timing values.

17. The method according to claim 12, further comprising displaying said the design of the integrated circuit, wherein layout elements assigned to the same group are marked in the same manner.

18. The method according to claim 17, wherein a region between and/or around adjacent layout elements assigned to different groups is marked if a predetermined condition is fulfilled.

19. The method according to claim 13, wherein layout elements assigned to the same group are displayed in a one-layer representation of the layout representation.

20. The method according to claim 13, wherein the simulatable representation is a representation in at least one of a schematic, SPICE, VHDL and any other net list format.

21. An integrated circuit comprising a conductor layer having a pattern chosen by analyzing a design of the integrated circuit, the step of analyzing comprising:
performing a simulation of the design of the integrated circuit to obtain simulation results; and
automatically associating the obtained simulation results to layout elements of the integrated circuit.

22. A method for analyzing an integrated circuit design, the method comprising:
providing a simulatable representation of the integrated circuit design;
performing a simulation of the integrated circuit to obtain simulation values;
providing a layout representation of the integrated circuit design; and
automatically associating the obtained simulation values to layout elements of the integrated circuit.

23. The method according to claim 22, further comprising:
providing groups defining value ranges for the simulation values; and
assigning elements to the provided groups in depending on their simulation values associated thereto.

24. The method according to claim 22, wherein the simulation values are electrical properties of the integrated circuit.

25. The method according to claim 22, wherein the simulation values comprise one or more of the following: voltage values, current values, current density values and timing values.

26. The method according to claim 23, further comprising displaying the integrated circuit design in the layout representation, wherein elements of the layout representation assigned to the same group are marked in the same manner.

27. The method according to claim 26, wherein, in the displaying step, a region between and/or around adjacent to elements assigned to different groups is marked if a predetermined condition is fulfilled.

28. The method according to claim 22, further comprising:
selecting a group; and
displaying elements of a respective layout assigned to the selected group in a separate layer representation of the layout representation.

29. The method according to claim 22, further comprising analyzing the layout representation.

30. The method according to claim 22, wherein the simulatable representation is a representation in at least one of a schematic, SPICE, VHDL and any other net list format.

31. A method of making an integrated circuit comprising forming a conductor layer having a pattern chosen by analyzing a design of the integrated circuit, the analyzing comprising:
providing a simulatable representation of the integrated circuit design;
performing a simulation of the integrated circuit to obtain simulation values;
providing a layout representation of the integrated circuit design; and
automatically associating the obtained simulation values to layout elements of the integrated circuit.

32. The method according to claim 31, further comprising:
providing groups defining value ranges for the simulation values; and
assigning elements to the provided groups depending on their simulation values associated thereto.

33. The method according to claim 31, wherein the simulation values are electrical properties of the integrated circuit.

34. The method according to claim 31, wherein the simulation values comprise one or more of the following: voltage values, current values, current density values and timing values.

35. The method according to claim 32, further comprising displaying the integrated circuit design in the layout representation, wherein elements of the layout representation assigned to the same group are marked in the same manner.

36. The method according to claim 35, wherein, in the displaying step, a region between and/or around adjacent to elements assigned to different groups is marked if a predetermined condition is fulfilled.

37. The method according to claim 31, further comprising:
selecting a group; and
displaying elements of a respective layout assigned to the selected group in a separate layer representation of the layout representation.

38. The method according to claim 31, further comprising analyzing the layout representation.

39. The method according to claim 31, wherein the simulatable representation is a representation in at least one of a schematic, SPICE, VHDL and any other net list format.

40. An integrated circuit comprising a conductor layer having a pattern chosen by analyzing a design of the integrated circuit, the step of analyzing comprising:
providing a simulatable representation of the integrated circuit design;
performing a simulation of the integrated circuit to obtain simulation values;
providing a layout representation of the integrated circuit design; and
automatically associating the obtained simulation values to layout elements of the integrated circuit.

41. A computer comprising a processor and a memory, the processor configured to perform any one of the methods according to claims 1, 11, 22, and 31.

42. A computer program product comprising program code means stored on a computer readable medium for performing any one of the methods according to claims 1, 11, 22, and 31.

43. A graphical representation of a layout of an integrated circuit, the graphical representation comprising a plurality of layout elements, wherein
electrical elements of the integrated circuit are represented by one or more of the layout elements; and
layout elements representing electrical elements having the same property are marked in the same way.

44. The graphical representation according to claim 43, wherein a region between and/or around adjacent polygons representing electrical elements having different properties and fulfilling a predetermined condition is marked.

45. A device for analyzing an integrated circuit design, the device comprising:
a simulator for performing a simulation of the integrated circuit design to obtain simulation values; and
an associating unit for automatically associating the obtained simulation values to layout elements of the integrated circuit.

46. The device according to claim 46, wherein the simulator performs the simulation on a simulatable representation of the integrated circuit, and wherein the associating unit performs the associating in a layout representation of the integrated circuit.

47. The device according to claim 45, wherein the simulation values are electrical properties of the integrated circuit.

48. The method according to claim 45, wherein the simulation values comprise one or more of the following: voltage values, current values, current density values and timing values.

49. A device for analyzing an integrated circuit design, the device comprising:
a receiving unit for receiving a simulatable representation and a layout representation of the integrated circuit design;
a simulator for performing a simulation of the integrated circuit to obtain simulation values; and
an associating unit for automatically associating the obtained simulation values to layout elements of the integrated circuit.
